(19) United States
(12) Patent Application Publication
(10) Pub. No.: US 2026/0258935 A1
(43) Pub. Date: Sep. 3, 2026

(54) LINEAR LIGHTING DEVICE WITH MULTIPLE PIVOTABLE LINEAR LIGHT SOURCES

(71) Applicant: SIGNIFY HOLDING B.V., EINDHOVEN (NL)

(72) Inventors: BARTEL MARINUS VAN DE SLUIS, EINDHOVEN (NL); MARCELLINUS PETRUS CAROLUS MICHAEL KRIJN, EINDHOVEN (NL); LEENDERT TEUNIS ROZENDAAL, VALKENSWAARD (NL); ANNA WILHELMINA MARIA DE BEST, VELDHOVEN (NL)

(21) Appl. No.: 18/876,004

(22) PCT Filed: Jun. 29, 2023
(86) PCT No.: PCT/EP2023/067880

§ 371 Date: Dec. 17, 2024

(30) Foreign Application Priority Data
Jul. 1, 2022 (EP) 22182564.9

(51) Int. Cl. F21V 21/30; F21V 11/02; F21Y 103/10; F21Y 115/10

(52) U.S. Cl. CPC F21V 21/30; F21V 11/02; F21Y 2103/10; F21Y 2115/10

(57) ABSTRACT

The invention provides a light generating system (1000) comprising light generating devices (100) and pivotable parts (400), wherein: the light generating devices (100) may comprise (i) a first linearly arranged light generating device (110), configured to generate first device light (111), and (ii) a second linearly arranged light generating device (120), configured to generate second device light (121); wherein the pivotable parts (400) may comprise a first pivotable part (410) and a second pivotable part (420), configured pivotable relative to each other over a pivot axis (Op); wherein the first pivotable part (410) may be configured to support the first linearly arranged light generating device (110); wherein the second pivotable part (420) may be configured to support the second linearly arranged light generating device (120); wherein the first linearly arranged light generating device (110) may comprise one or more first solid state light sources (10); wherein the second linearly arranged light generating device (120) may comprise one or more second solid state light sources (20); and wherein in a first operational mode of the light generating system (1000), the first device light (111) and the second device light (121) may differ in color point.

### FIELD OF THE INVENTION

The invention relates to a light generating system. The invention further relates to a lighting device (comprising such light generating system). Yet further, the invention relates to an arrangement (of such light generating system).

### BACKGROUND OF THE INVENTION

Pivotable light generating devices are known in the art. For instance, US20160102824A1, describes a light fixture including a housing, the housing including a back portion and a plurality of side walls extending from the back portion, the back portion and the plurality of side walls defining an opening and an interior therein. A light source is affixed to the back portion within the interior. A hinge is coupled to the housing and positioned within the interior, the hinge includes a first portion and a second portion, the first portion and second portion being configured to reflect light emitted from the light source.

The first portion and the second portion being movable contemporaneously from a first portion in which light from the light source is substantially entirely reflected in a first direction away from the housing to a second position in which light is substantially entirely reflect reflected away from the housing in a second direction different than the first direction. WO2015121761A1 discloses a tubular lighting fixture comprising a second strip of LED-based light sources movable about an arc relative to a first strip of LED-based light sources.

### SUMMARY OF THE INVENTION

More and more linear lighting devices are introduced to the market. An example is the Hue Signe, which is a wall-washer that can be positioned in front of a wall to create wall-washing ambience effects. Linear LED arrays enable compact wall-washers such as the Hue Signe. However, the Signe may be positioned at various positions, such as in the middle of a wall or in a room corner, which would require different beam widths and intensities. Current linear lighting devices are limited in their ability to adjust their beam width and intensity to the orientation of the lighting device accordingly. Additionally, linear lighting devices may be difficult to transport or store properly, due to their rigid shapes, i.e. limited flexibility.

Hence, it is an aspect of the invention to provide an alternative linear light generating device, which preferably further at least partly obviates one or more of above-described drawbacks. The present invention, as set out in the appended claims, may have as an object to overcome or ameliorate at least one of the disadvantages of the prior art, or to provide a useful alternative.

According to a first aspect, the invention provides a light generating system (“system”) comprising light generating devices and pivotable parts. In embodiments, the light generating devices may comprise a first linearly arranged light generating device and a second linearly arranged light generating device. Especially, in embodiments, the first linearly arranged light generating device may be configured to generate first device light.

Likewise, in embodiments, the second linearly arranged light generating device may be configured to generate second device light. The pivotable parts may, in embodiments, comprise a first pivotable part and a second pivotable part. Further, the first and second pivotable parts may be configured pivotable relative to each other over a pivot axis Op. Yet further, in embodiments, the first pivotable part may be configured to support the first linearly arranged light generating device. Likewise, the second pivotable part may be configured to support the second linearly arranged light generating device. In embodiments, the first linearly arranged light generating device may comprise one or more first solid state light sources. Especially, the first linearly arranged light generating device may, in embodiments, comprise a plurality of linearly arranged first solid state light sources.

Likewise, in embodiments, the second linearly arranged light generating device may comprise one or more second solid state light sources. Especially, the second linearly arranged light generating device may, in embodiments, comprise a plurality of linearly arranged second solid state light sources. Additionally or alternatively, in a first operational mode of the light generating system, the first device light and the second device light may differ in color point. Typically, the first pivotable part and the second pivotable part have a mutual orientation over the pivot axis Op at a variable pivot angle α. The light generating system, in an operational mode, is configured to generate system light comprising device light of at least one of the first device light and the second device light. In embodiments, the light generating system further may comprise a control system configured to control the device light, wherein typically during an on-state of the light generating system the control system is configured to control the system light in dependence of the variable pivot angle α. Furthermore, in embodiments, the first linearly arranged light generating device may be configured to generate a first linear beam of first device light. Especially, the first solid state light sources may be configured to generate first solid state light source light. More especially, in embodiments, the first device light may comprise the first solid state light source light of one or more of the first solid state light sources. Likewise, in embodiments, the second linearly arranged light generating device may be configured to generate a second linear beam of second device light. Especially, the second solid state light sources may be configured to generate second solid state light source light. More especially, in embodiments, the second device light may comprise the second solid state light source light of one or more of the second solid state light sources. Additionally or alternatively, in embodiments, one or more of the first linearly arranged light generating device and the second linearly arranged light generating device may comprise one or more of: (i) a LED filament, (ii) a LED strip, and (iii) an elongated lightguide element comprising linearly arranged light outcoupling parts. Hence, in a specific embodiment, the invention provides a light generating system comprising light generating devices and pivotable parts, wherein: the light generating devices may comprise (i) a first linearly arranged light generating device, configured to generate first device light, and (ii) a second linearly arranged light generating device, configured to generate second device light; wherein the pivotable parts may comprise a first pivotable part and a second pivotable part, configured pivotable relative to each other over a pivot axis (Op); wherein the first pivotable part may be configured to support the first linearly arranged light generating device; wherein the second pivotable part may be configured to support the second linearly arranged light generating device; wherein the first linearly arranged light generating device may comprise one or more first solid state light sources; wherein the second linearly arranged light generating device may comprise one or more second solid state light sources; and wherein in a first operational mode of the light generating system, the first device light and the second device light may differ in color point.

With the present system, it may be possible to provide a compact light generating system configured to provide linear ambience effects, such as a wall-washer or a dual-function luminaire. Furthermore, the system may provide flexibility, i.e. it allows changing of the linear orientation of the light sources relative to each other to enable (manual of motorized) beam width adjustment. This flexibility may also enable easy transportation and storage of the light generating system.

Here below, first some general embodiments of the system are described, followed by some more specific embodiments.

In embodiments, the light generating system may comprise light generating devices and pivotable parts. Especially, the light generating system may comprise a unit, wherein the unit comprises the light generating devices and the pivotable parts.

The light generating devices may, in embodiments, comprise a first linearly arranged light generating device and a second linearly arranged light generating device. In embodiments, the first linearly arranged light generating device and the second linearly arranged light generating device may have a first linearly arranged light generating device length L_{d1} and a second linearly arranged light generating device length L_{d2}. Especially, in embodiments, L_{d1} and L_{d2} may be separately selected from the range of 0.5-150 cm, such as from the range of 1-100 cm, like from the range of 1-50 cm, especially from the range of 5-15 cm. Hence, in embodiments, the first linearly arranged light generating device and the second linearly arranged light generating device may have lengths selected such that L_{d1} may be equal to L_{d2}, i.e. L_{d1}=L_{d2}. However, in alternative embodiments, L_{d1} may not be equal to L_{d2}, i.e. L_{d1}≠L_{d2}. Furthermore, in embodiments, the first linearly arranged light generating device and the second linearly arranged light generating device may have a first cross-sectional dimension Dai and a second cross-sectional dimension D_{d2}, respectively. The first cross-sectional dimension Dai and the second cross-sectional dimension D_{d2} may have a maximum separately selected from the range of ≤50 mm, such as from the range of ≤25 mm, like from the range of ≤15 mm, especially from the range of ≤10 mm, more especially from the range of ≤5 mm. Further, in embodiments, the first cross-sectional dimension D_{d1} and the second cross-sectional dimension D_{d2} may have a minimum separately selected from the range of ≥1 mm, such as from the range of ≥2 mm, like from the range of ≥5 mm, especially from the range of ≥10 mm. Hence, in embodiments, the first linearly arranged light generating device and the second linearly arranged light generating device may have cross-sectional dimensions selected such that Dai may be equal to D_{d2}, i.e. D_{d1}=D_{d2}. However, in alternative embodiments, Dai may not be equal to D_{d2}, i.e. D_{d1}≠D_{d2}.

Additionally or alternatively, the first linearly arranged light generating device and the second linearly arranged light generating device may have an aspect ratio, which may be defined as the linearly arranged light generating device length over the cross-sectional dimension, i.e. a first aspect ratio L_{d1}/D_{d1} and a second aspect ratio L_{d2}/D_{d2}. In embodiments the aspect ratios L_{d1}/D_{d1} and L_{d2}/D_{d2} may have a value separately selected from the range of ≥3, such as from the range of ≥4, especially from the range of ≥5, like from the range of ≥10, such as from the range of ≥50, especially from the range of ≥100, more especially from the range of ≥1000. Hence, in embodiments, the first aspect ratio L_{d1}/D_{d1} and the second aspect ratio L_{d2}/D_{d2} may be equal. However, in alternative embodiments, the first aspect ratio L_{d1}/D_{d1} and the second aspect ratio L_{d2}/D_{d2} may not be equal. Further, the light generating devices may be configured to generate device light. Especially, the first linearly arranged light generating device may be configured to generate first device light. Likewise, the second linearly arranged light generating device may be configured to generate second device light. As already stated, the pivotable parts may, in embodiments, comprise a first pivotable part and a second pivotable part. The first and second pivotable parts may be configured pivotable relative to each other. Hence, in embodiments, the first pivotable part and the second pivotable part may have a variable absolute and/or relative orientation to each other.

Especially, in embodiments, the first pivotable part and the second pivotable part may rotate about an axis of rotation. The first pivotable part may have an axis of elongation. A mutual angle β₁ between the first pivotable part and the axis of rotation may e.g. be selected from 0° and 90°, but may also be selected from the range of 0-90°. When the mutual angle β₁ is 0°, then the first pivotable part and the axis or rotation are configured parallel. When the mutual angle β₁ is 90°, then the first pivotable part and the axis of rotation are configured orthogonal. A mutual angle β₂ between the second pivotable part and the axis or rotation may e.g. (also) be selected from 0° and 90°, but may also be selected from the range of 0-90°. When the mutual angle β₂ is 0°, then the second pivotable part and the axis of rotation are configured parallel. When the mutual angle β₂ is 90°, then the second pivotable part and the axis of rotation are configured orthogonal. Especially, in embodiments both mutual angles are the same. Would the mutual angles between the first pivotable part and the axis of rotation and between the second pivotable part and the axis of rotation both be 0°, then the first pivotable part, the axis of rotation, and the second pivotable part may be configured parallel. Would the mutual angles between the first pivotable part and the axis of rotation and between the second pivotable part and the axis or rotation both be 90°, then the first pivotable part, and the second pivotable part may both be configured orthogonal to the axis of rotation.

Optionally, at least one of the pivotable parts may additionally be pivotable over a respective pivotable part axis of elongation O_{Lx}, for example, pivotable over an angle range of 180°.

Further, in embodiments, the first pivotable part may be configured to support the first linearly arranged light generating device. Likewise, the second pivotable part may, in embodiments, be configured to support the second linearly arranged light generating device. In this way, the first linearly arranged light generating device and the second linearly arranged light generating device may be configured pivotable relative to each other.

The first pivotable part and the second pivotable part may, in embodiments, be configurable perpendicular to each other in length, i.e. the first pivotable part and the second pivotable part are perpendicular in length to the central support element. In other embodiments, the first pivotable part and the second pivotable part may be configurable parallel to each other in length. In yet other embodiments, the first pivotable part and the second pivotable part may be configurable diagonal to each other in length. Yet further, in embodiments, the first pivotable part and the second pivotable part may be configurable in symmetrical angles relative to each other and a surface to be illuminated. However, the first pivotable part and the second pivotable part may also, in embodiments, be configurable in asymmetrical angles relative to each other and a surface to be illuminated. Hence, in embodiments, the first pivotable part and the second pivotable part may-in operation-be pivotable relative to each other, enabling the light generating system to switch between a plurality of different configurations.

Further, in embodiments, the first linearly arranged light generating device may comprise one or more first solid state light sources. Likewise, in embodiments, the second linearly arranged light generating device may comprise one or more first solid state light sources. The number of first solid state light sources and/or second solid state light sources may be separately selected from the range of 1-2000, such as from the range of 2-2000, like from the range of 10-1000, especially from the range of 25-500, more especially from the range of 50-200. Hence, in embodiments, the amount of first solid state light sources may be equal to the amount of second solid state light sources. However, in other embodiments, the amount of first solid state light sources may not be equal to the amount of second solid state light sources. Yet further, the first and second solid state light sources may, in embodiments, be solid state light sources selected from the group comprising LEDs, OLEDs, PLEDs, and other solid state light sources (see also further below).

Yet further, in embodiments, the light generating system may have at least a first operational mode. In the first operational mode of the light generating system, in embodiments, the first device light and the second device light may differ in color point (see also further below). In embodiments, the light generating system may have a plurality of operational modes.

The first linearly arranged light generating device may, in embodiments, be configured to generate a first linear beam of first device light. Hence, in embodiments, the first linearly arranged light generating device may comprise a plurality of linearly arranged first solid state light sources. Further, the first solid state light sources may be configured to generate first solid state light source light. In embodiments, the first device light may comprise at least part of the first solid state light source light of one or more of the first solid state light sources. Especially, in embodiments, the first device light may comprise at least part of the first solid state light source light of one or more of the linearly arranged first solid state light sources.

The second linearly arranged light generating device may, in embodiments, be configured to generate a second linear beam of second device light. Hence, in embodiments, the second linearly arranged light generating device may comprise a plurality of linearly arranged second solid state light sources. Further, the second solid state light sources may be configured to generate second solid state light source light. In embodiments, the second device light may comprise at least part of the second solid state light source light of one or more of the second solid state light sources. Especially, in embodiments, the second device light may comprise at least part of the second solid state light source light of one or more of the linearly arranged second solid state light sources.

A linear beam of device light may be defined as a beam of device light having a light distribution which is elongated such that the light beam extends at least two or three times more in the length direction compared to light extending in the transverse direction.

Further, in embodiments, one or more of the first linearly arranged light generating device and the second linearly arranged light generating device may comprise one or more of: (i) a LED filament, (ii) a LED strip, and (iii) an elongated lightguide element comprising linearly arranged light outcoupling parts. Thus, in embodiments, the first linearly arranged light generating device may comprise one or more of: (i) a LED filament, (ii) a LED strip, and (iii) an elongated lightguide element comprising linearly arranged light outcoupling parts. Especially, in embodiments, the first linearly arranged light generating device may comprise a LED filament. In alternative embodiments, the first linearly arranged light generating device may comprise a LED strip. In yet alternative embodiments, the first linearly arranged light generating device may comprise an elongated lightguide elements comprising linearly arranged light outcoupling parts. The second linearly arranged light generating device may comprise essentially the same of one or more of: (i) a LED filament, (ii) a LED strip, and (iii) an elongated lightguide element (comprising linearly arranged light outcoupling parts) as the first linearly arranged light generating device. However, in embodiments, the second linearly arranged light generating device may comprise essentially not the same of one or more of: (i) a LED filament, (ii) a LED strip, and (iii) an elongated lightguide element (comprising linearly arranged light outcoupling parts) (functionally coupled to a light source) as the first linearly arranged light generating device.

Especially, an LED filament may be configured to provide LED filament light. The term “LED filament light” may refer to the light of the LED filament during operation of the LED filament. The LED filament may in embodiments comprises a plurality of light emitting diodes (LEDs), especially arranged in a linear array.

The linear array may be a 1D or 2D array, of n*m LEDs, wherein n may in embodiments be selected from the range of 1-4, such as 1-3, like 1-2, such as in embodiments 1 or in embodiments 2, and m may be selected from the range of larger than n, such as especially selected from the range of at least 4 (when n<4), like at least 6, such as at least 8.

Further, the LEDs may be arranged for emitting LED light e.g. of different colors or spectral power distributions. In embodiments, two or more LEDs may be configured to provide light having essentially the same spectral power distributions. Even more especially, in embodiments all LEDs may be configured to provide light having essentially the same spectral power distributions. In yet other embodiments, two or more LEDs may be configured to provide light having different spectral power distributions.

In embodiments, the LED filament may have a length L and a width W, with in specific embodiments L≥5 W. The LED filament may be arranged in a straight configuration or in a non-straight configuration, such as for example a curved configuration, a (2D or 3D) spiral, or a helix.

In specific embodiments, the LEDs may be arranged on an (elongated) carrier like for instance a substrate. In embodiments, the (elongated) carrier may be rigid (made from e.g. a polymer, glass, quartz, metal or sapphire) or flexible (e.g. made of a polymer or metal e.g. a film or foil).

In case the carrier comprises a first major surface and an opposite second major surface, the LEDs are arranged on at least one of these surfaces. In embodiments, the carrier may be light reflective, especially reflective for the filament light. In embodiments, the carrier may be light transmissive, such as translucent and in specific embodiments transparent.

In embodiments, the LED filament may comprise an encapsulant at least partly covering at least part of the total number of LEDs (of the plurality of LEDs). In specific embodiments, the encapsulant may also at least partly cover at least one of the first major or second major surface.

The encapsulant may comprise a polymer material which may in embodiments be flexible such as for example a silicone. In embodiments, the encapsulant may comprise a resin.

In embodiments, the encapsulant may comprise one or more of a luminescent material and a light scattering material. The one or more of the luminescent material and the light scattering material may be embedded in the encapsulant material, such as the polymer material. The luminescent material may especially be configured to at least partly convert LED light into converted light. The luminescent material may also be indicated as “phosphor”. The luminescent material may comprise a phosphor such as an inorganic phosphor and/or quantum dots or rods.

Hence, the LED filament light may comprise in specific embodiments one or more of LED light and converted light (“luminescent material light”).

In embodiments, the LED filament may comprise multiple sub-filaments.

As indicated above, the LED filament may in embodiments comprises a plurality of light emitting diodes. However, the term LED in the context of LED filament, may also refer to solid state light sources (in general). Hence, the LED filament may comprise one or more of LEDs, laser diodes, and superluminescent diodes. Especially, the LED filament comprises a plurality of light emitting diodes (LEDs).

In embodiments, the LED strip may comprise a plurality of LEDs (see also further below). The LED strip may be flexible. Further, in embodiments, the first and/or second linearly arranged light generating device may comprise a plurality of LED strips. For instance, n LED strips may be applied. Especially, the LED strip may comprise a flexible support configured to support a plurality of LEDs and comprising electrical conductors to electrically connect the LEDs to a source of electricity.

A lightguide element comprising linearly arranged light outcoupling parts may especially refer to an elongated light guide, comprising outcoupling elements at its surface and/or in the bulk of the light guide material. The light guide material is especially light transmissive material. Especially, the material has a light transmission in the range of 50-100%, especially in the range of 70-100%, for light having a wavelength selected from the visible wavelength range. Herein, the term “visible light” especially relates to light having a wavelength selected from the range of 380-780 nm.

The transmission (or light permeability) can be determined by providing light at a specific wavelength with a first intensity to the light transmissive material under perpendicular radiation and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

In specific embodiments, a material may be considered transmissive when the transmission of the radiation at a wavelength or in a wavelength range, especially at a wavelength or in a wavelength range of radiation generated by a source of radiation as herein described, through a 1 mm thick layer of the material, especially even through a 5 mm thick layer of the material, under perpendicular irradiation with said radiation is at least about 20%, such as at least 40%, like at least 60%, such as especially at least 80%, such as at least about 85%, such as even at least about 90%.

The light transmissive material has light guiding or wave guiding properties. Hence, the light transmissive material is herein also indicated as waveguide material or light guide material. The light transmissive material will in general have (some) transmission of one or more of (N)UV, visible and (N)IR radiation, such as in embodiments at least visible light, in a direction perpendicular to the length of the light transmissive material. Without the activator (dopant) such as trivalent cerium, the internal transmission in the visible might be close to 100%.

The transmission of the light transmissive material (as such) for one or more luminescence wavelengths may be at least 80%/cm, such as at least 90%/cm, even more especially at least 95%/cm, such as at least 98%/cm, such as at least 99%/cm. This implies that e.g. a 1 cm³ cubic shaped piece of light transmissive material, under perpendicular irradiation of radiation having a selected luminescence wavelength (such as a wavelength corresponding to an emission maximum of the luminescence of the luminescent material of the light transmissive material), will have a transmission of at least 95%.

Herein, values for transmission especially refer to transmission without taking into account Fresnel losses at interfaces (with e.g. air). Hence, the term “transmission” especially refers to the internal transmission. The internal transmission may e.g. be determined by measuring the transmission of two or more bodies having a different width over which the transmission is measured. Then, based on such measurements the contribution of Fresnel reflection losses and (consequently) the internal transmission can be determined. Hence, especially, the values for transmission indicated herein, disregard Fresnel losses.

In embodiments, an anti-reflection coating may be applied to the luminescent body, such as to suppress Fresnel reflection losses (during the light incoupling process).

In addition to a high transmission for the wavelength(s) of interest, also the scattering for the wavelength(s) may especially be low. Hence, the mean free path for the wavelength of interest only taking into account scattering effects (thus not taking into account possible absorption (which should be low anyhow in view of the high transmission), may be at least 0.5 times the length of the body, such as at least the length of the body, like at least twice the length of the body. For instance, in embodiments the mean free path only taking into account scattering effects may be at least 5 mm, such as at least 10 mm. The wavelength of interest may especially be the wavelength at maximum emission of the luminescence of the luminescent material. The term “mean free path” is especially the average distance a ray will travel before experiencing a scattering event that will change its propagation direction.

In embodiments, the element comprising the light transmissive material may essentially consist of the light transmissive material. In specific embodiments, the element comprising the light transmissive material may be a light transparent element.

Especially, the light transmissive element, such as the light transparent element, may in embodiments have an absorption length and/or a scatter length of at least the length (or thickness) of the light transmissive element, such as at least twice the length of the light transmissive element. The absorption length may be defined as the length over which the intensity of the light along a propagation direction due to absorption drops with 1/e. Likewise, the scatter length may be defined as the length along a propagation direction along which light is lost due to scattering and drops thereby with a factor 1/e. Here, the length may thus especially refer to the distance between a primary face and a secondary face of the light transmissive element, with the light transmissive material configured between the primary face and the secondary face.

The lightguide element comprising linearly arranged light outcoupling parts may functionally be coupled to a light source, which is configured to generate light source light. The light guide element such as its primary face or its secondary face, may be configured in a light receiving relationship with the light source. Especially, such light source may be a solid state light source.

The terms “light-receiving relationship” or “light receiving relationship”, and similar terms, may indicate that an item may during operation of a source of light (like a light generating device or light generating element or light generating system) may receive light from that source of light. Hence, the item may be configured downstream of that source of light. Between the source of light and the item, optics may be configured. The terms “upstream” and “downstream”, such as in the context of propagation of light, may especially relate to an arrangement of items or features relative to the propagation of the light from a light generating element (here especially the light generating system), wherein relative to a first position within a beam of light from the light generating element, a second position in the beam of light closer to the light generating element (than the first position) is “upstream”, and a third position within the beam of light further away from the light generating element (than the first position) is “downstream”. For instance, instead of the term “light generating element” also the term “light generating means” may be applied.

Yet further, in embodiments, the first and/or second linearly arranged light generating devices may comprise a diffuser.

In embodiments, in the first operational mode of the light generating system a first color point of the first device light and a second color point of the second device light may differ with at least 0.03 for u′ and/or with at least 0.03 for v′ (see also below).

With the present system, it may be possible to provide light with at least two different colors or shades. Additionally or alternatively, it may be possible to provide light with a color gradient.

In embodiments, in the first operational mode of the light generating system the first device light may have a first color point and the second device light may have a second color point. Especially, in embodiments, the first color point of the first device light and the second color point of the second device light may differ with at least 0.03 for u′ and/or with at least 0.03 for v′, such as at least 0.05 for u′ and/or v′, like at least 0.1 for u′ and/or v′, especially at least 0.25 for u′ and/or v′. Hence, in embodiments, the first color point may have the same value for u′ as the second color point, while differing with at least 0.03 for v′. Likewise, in other embodiments, the first color point may have the same value for v′ as the second color point, while differing with at least 0.03 for u′. In yet other embodiments, the first color point and the second color point may differ with at least 0.03 for both u′ and v′ simultaneously. For example, in embodiments, the first device light may be blue light and the second device light may be green light. Furthermore, u′ and v′ may be color coordinates of the light in the CIE 1976 UCS (uniform chromaticity scale) diagram.

In embodiments, the pivotable parts may comprise pivotable part lengths Lₚ. Furthermore, in embodiments, the pivotable parts may comprise maximum cross-sectional dimensions Dₚ, configured perpendicular to the respective pivotable part lengths Lₚ. Especially, in embodiments, Lₚ/Dₚ≥5. Hence, in a specific embodiment, the pivotable parts may comprise pivotable part lengths Lₚ and maximum cross-sectional dimensions D_{d}, wherein Lₚ/Dₚ≥5. Especially, in embodiments, the pivotable part lengths Lₚ may be selected from the range of 5-150 cm. Furthermore, the maximum cross-sectional dimensions may, in embodiments, be selected from the range of 2-50 mm.

A pivotable part length may be defined as the length of the largest side of the pivotable part. The pivotable part length may be individually selected for the pivotable parts. Thus, in embodiments, the first pivotable part may have a first pivotable part length Lₚ₁. Likewise, the second pivotable part may have a second pivotable part length Lₚ₂. In embodiments, the pivotable part lengths Lₚ may be selected from the range of 5-150 cm, such as from the range of 10-100 cm, like from the range of 25-80 cm, especially from the range of 30-60 cm.

In embodiments, the pivotable parts may comprise maximum cross-sectional dimensions Dₚ configured perpendicular to the respective pivotable part lengths Lₚ. The maximum cross-sectional dimension may be individually selected for the pivotable parts. Thus, in embodiments, the first pivotable part may have a first maximum cross-sectional dimension Dₚ₁. Likewise, the second pivotable part may have a second maximum cross-sectional dimension Dₚ₂. In embodiments, the maximum cross-sectional dimensions Dₚ may be selected from the range of 2-50 mm, such as from the range of 2-30 mm, like from the range of 5-20 mm, especially from the range of 8-15 mm.

Further, in embodiments, the pivotable part length Lₚ and the maximum cross-sectional dimensions Dₚ may have a ratio Lₚ/Dₚ individually selected for each pivotable part from the range of ≥3, such as from the range of ≥4, especially from the range of ≥5, like from the range of ≥10, such as from the range of ≥50, especially from the range of ≥100, more especially from the range of ≥1000.

Additionally or alternatively, in embodiments, the first (and/or second) linearly arranged light generating device may emit first (and/or second) device light over at least 50% of the pivotable part length Lₚ of the respective pivotable part, such as over at least 60%, like over at least 70%, especially over at least 80%, more especially over at least 90%, like over at least 95%, including over 100% of the pivotable part length Lₚ. Hence, in embodiments, the first (and/or second) linearly arranged light generating device may emit first (and/or second) device light over at least part of the full length of the respective pivotable part. Especially, in embodiments, the first (and/or second) linearly arranged light generating device may emit first (and/or second) device light over the full length of the respective pivotable part.

As already mentioned, in embodiments, the first pivotable part and the second pivotable part may have a mutual orientation over a pivot axis Op at a variable pivot angle α. Especially, in embodiments, a difference between a minimum pivot angle α₁ and a maximum pivot angle α₂ may be at least 45°, such as at least about 90 °. Additionally or alternatively, in embodiments, the difference between the minimum pivot angle α₁ and the maximum pivot angle α₂ may be selected from the range of 90-360°, or even 45-360°. Hence, in a specific embodiment, the first pivotable part and the second pivotable part may have a mutual orientation over a pivot axis Op at a variable pivot angle α, wherein a difference between a minimum pivot angle α₁ and a maximum pivot angle α₂ may be at least 45°.

The light generating system may be configured to generate system light. In an operational mode of the light generating system the system light may comprise device light of at least one of the light generating devices. Especially, in embodiments, the system light may comprise at least one of the first device light and the second device light.

The pivot axis Op may be defined as an imaginary line perpendicular to the direction in which system light propagates out of the light generating system. This pivot axis Op may be centered between the first pivotable part and the second pivotable part.

In embodiments, the first pivotable part and the second pivotable part may have a mutual orientation over the pivot axis Op, such that a variable pivot angle α may exist. The variable pivot angle α may have a minimum pivot angle α₁ and a maximum pivot angle α₂. The minimum pivot angle α₁ may, in embodiments, be selected from the range of 0-315°, such as from the range of 45-270°, like from the range of 90-180°. Hence, the minimum pivot angle α₁ may be ≤315°, such as ≤180°, like ≤90°, especially ≤45°, more especially ≤15°, including 0°. The maximum pivot angle α₂ may, in embodiments, be selected from the range of 45-360°, such as from the range of 90-315°, like from the range of 180-270. Hence, the maximum pivot angle α₂ may be ≥45°, such as ≥90°, like ≥180°, especially ≥270°, including 360°.

Furthermore, in embodiments, the difference between the minimum pivot angle α₁ and the maximum pivot angle α₂ may be at least 45°, such as at least 60°, like at least 90°, especially at least 120°, more especially at least 180°. In embodiments, the difference between the minimum pivot angle α₁ and the maximum pivot angle α₂ may be selected from the range of 45-360°, such as from the range of 90-330°, like from the range of 150-300°, especially from the range of 180-270°. For example, in a specific embodiment, the variable pivot angle α may be variable between a minimum pivot angle α₁ of 180° and a maximum pivot angle α₂ of 225°, thus the variable pivot angle α may herein be variable over 45°. In yet another example, the variable pivot angle α may be variable between a minimum pivot angle α₁ of 0° and a maximum pivot angle α₂ of 90°, thus the variable pivot angle α may herein be variable over 90°.

In embodiments, at least one of the first linearly arranged light generating device and the second linearly arranged light generating device may be configured to generate colored device light. In specific embodiments, the first linearly arranged light generating device and the second linearly arranged light generating device may both be configured to generate colored device light. In other embodiments, the first linearly arranged light generating device may be configured to generate colored device light, while the second linearly arranged light generating device may not be configured to generate colored device light. Colored device light may be e.g. violet, blue, blue green, green, yellow, orange or red light.

The terms “violet light” or “violet emission”, and similar terms, may especially relate to light having a wavelength in the range of about 380-440 nm. In specific embodiments, the violet light may have a centroid wavelength in the 380-440 nm range. The terms “blue light” or “blue emission”, and similar terms, may especially relate to light having a wavelength in the range of about 440-490 nm (including some violet and cyan hues). In specific embodiments, the blue light may have a centroid wavelength in the 440-490 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range. The terms “visible”, “visible light” or “visible emission” refer to light having a wavelength in the range of about 380-780 nm.

Further, in embodiments, at least one of the first linearly arranged light generating device and the second linearly arranged light generating device may be configured to generate device light having a controllable spectral power distribution. In embodiments, the first linearly arranged light generating device light may comprise a first spectral power distribution. Likewise, the second linearly arranged light generating device light may comprise a second spectral power distribution. In specific embodiments, the first linearly arranged light generating device and the second linearly arranged light generating device may both be configured to generate device light having a controllable spectral power distribution. In other embodiments, the first linearly arranged light generating device may be configured to generate device light having a controllable first spectral power distribution, while the second linearly arranged light generating device may be configured to generate device light having a fixed second spectral power distribution.

Furthermore and as mentioned earlier, in embodiments, the light generating system may comprise a control system (see also further below). The control system may, in embodiments, be configured to control the controllable spectral power distribution of the device light of at least one of the first linearly arranged light generating device and the second linearly arranged light generating device.

The control system may in embodiments be comprised by the arrangement. In other embodiments, the control system may be configured external of the arrangement, and may be functionally coupled thereto (especially the linearly arranged light generating devices). The light generating system may, in embodiments, comprise a control system directly coupled to the light generating devices. However, in embodiments, the light generating system may be functionally coupled to an external control system.

In embodiments, the light generating system may comprise a second operational mode. Especially, in the second operational mode of the light generating system a spectral power distribution of at least one of the first device light and the second device light may spatially differ in color point along at least part of the pivotable part length Lₚ of the respective pivotable part.

In the second operational mode of the light generating system, in embodiments, the spectral power distribution of both of the first device light and the second device light may spatially differ in color point along at least part of the pivotable part lengths Lₚ of the respective pivotable parts. In other embodiments, in the second operational mode of the light generating system only one of the first device light and the second device light may spatially differ in color point along at least part of the pivotable part length Lₚ of the respective pivotable part.

In embodiments, the first (and/or second) device light may have two or more different colors along at least part of the pivotable part length Lₚ of the respective pivotable part. For example, in embodiments, the first (and/or second) device light may have a blue color along one part of the pivotable part length Lₚ of the respective pivotable part and a green color along the other part. In other embodiments, the first (and/or second) device light may have two or more colors in a regularly alternating pattern along at least part of the pivotable part length Lₚ of the respective pivotable part. In yet other embodiments, the first (and/or second) device light may have two or more colors in an irregularly alternating pattern along at least part of the pivotable part length Lₚ of the respective pivotable part. In yet other embodiments, the first (and/or second) device light may have a rainbow colored pattern along at least part of the pivotable part length Lₚ of the respective pivotable part. Hence, in embodiments, the first (and/or second) device light may have a gradient of color along at least part of the pivotable part length Lₚ of the respective pivotable part. These described embodiments may be seen as examples of different operational modes of the light generating system as discussed above and further below.

In embodiments, the light generating system may be configured to generate system light. Especially, the system light may comprise, in an operational mode of the light generating system, device light of at least one of the light generating devices. More especially, in embodiments, the system light may comprise, in an operational mode of the light generating system, device light of at least one of the first device light and the second device light. Further, in embodiments, the light generating system may comprise a control system configured to control the device light. Especially, the control system may, in embodiments, be configured to control the device light in dependence of one or more of an input signal of a user interface, a sensor signal of a sensor, and a timer. Hence, in a specific embodiment, the light generating system may be configured to generate system light, wherein the system light may comprise, in an operational mode of the light generating system, device light of at least one of the first device light and the second device light, wherein the light generating system may further comprise a control system configured to control the device light in dependence of one or more of an input signal of a user interface, a sensor signal, and a timer.

This may be advantageous, because it may enable the light generating system to automatically adjust the light settings based on the detection of the absolute orientation (vertical vs horizontal) and the relative orientation (e.g. opening angle) of the first and second linearly arranged light generating devices.

The light generating system may have a first and a second operational mode, as described above. However, in embodiments, the light generating system may have additional or alternative operational modes. For example, in an operational mode of the light generating system the system light may comprise device light of at least one of the light generating devices. Especially, in embodiments, in an operational mode of the light generating system the system light may comprise device light of at least one of the first device light and the second device light. Hence, in embodiments, the light generating system may comprise an operational mode comprising either the first or the second linearly arranged light generating device being turned on. Yet in another operational mode both the first and the second linearly arranged light generating devices may be turned on. In yet another operational mode the first and second linearly arranged light generating devices may both be turned off.

Further, in embodiments, the light generating system may comprise a control system (see also above and further below) configured to control the device light in dependence of one or more input signals. Such input signal may, for example, be an input signal of one or more of a user interface, a motion sensor, a distance sensor, an integrated orientation sensor, a timer, and an input signal generated by a user-controlled mobile device.

Sensors may detect the absolute orientation (e.g. vertical or horizontal orientation) of the linearly arranged light generating devices, the relative orientation (e.g. the variable pivot angle) of the linearly arranged light generating devices, and the distance of the linearly arranged light generating devices to the effect surfaces (e.g. a wall or a ceiling). Based on such detection, the sensors may send signals to the control system, which may in turn control the device light.

A sensor as discussed above may, in embodiments, be configured attached onto or incorporated in the light generating devices. However, in other embodiments, the sensor may also be a sensor external from the light generating devices but functionally coupled, like attached or integrated, in the pivotable parts. In yet other embodiments, the sensor may be configured elsewhere in the arrangement, or even external from the arrangement.

In specific embodiments, each pivotable part may comprise a sensor configured to generate an orientation signal, e.g. an accelerometer.

The term “sensor” may also refer to a plurality of (different) sensors.

The sensor may in embodiments comprise one or more sensors selected from the group of an ambient light sensor (e.g. for sensing light in a space, such as a room), outdoor light sensor, temperature sensor, proximity sensor, movement sensor, etc.

The term “timer” may refer to a clock and/or a predetermined time scheme.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc.. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc.. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, which can only operate in a single operation mode (i.e. “on”, without further tunability).

As said, in embodiments, the control system may be configured to control the device light in dependence of the variable pivot angle α. This may be advantageous, for example, when the light generating system may be used as part of a vertical wall-washer. The intensity of the light output (e.g. brightness or color gradient) may be adjusted to the variable pivot angle α of the first and second linearly arranged light generating devices arranged pivotable relative to each other. Hence, in embodiments, the control system may be configured to increase or decrease the brightness of the first (and/or second) linearly arranged light generating device when the variable pivot angle α increases. However, the control system may also be configured to increase or decrease the brightness of the first (and/or second) linearly arranged light generating device when the variable pivot angle α decreases. In other embodiments, the control system may be configured to change the color (gradient) of the first (and/or second) linearly arranged light generating device in response to a change in the variable pivot angle α.

In another example, when the light generating system may be used as a pendant lamp structure (e.g. above a table), a productivity light setting may be activated by the control system when all linearly arranged light generating devices are oriented downwards. Additionally or alternatively, an ambience creation setting may be activated for linearly arranged light generating devices oriented upwards to the ceiling (possibly combined with a productivity light setting oriented downwards to the table to obtain a dual-function mode). Other examples of light settings dependent on the variable pivot angle α may be possible as well.

Hence, the light generating system according to the invention may have the feature that the control of the system light in dependence of the variable pivot angle (a) relates to at least one of i) intensity level of at least one of the first device light and the second device light; ii) intensity ratio of the first device light and second device light; iii) emission spectrum of at least one of the first device light and the second device light; and iv) difference in color, color temperature or correlated color temperature of the first device light and the second device light.

Further, in embodiments, the control system may be configured to control the device light in dependence of a distance to a surface illuminated by the light generating device. This may be advantageous as this may allow the light generating system to adjust the light setting to its distance to for example a wall. In this way a lamp comprising the light generating system may be able to provide improved optical performances in varying orientations.

In embodiments, the light generating system may be configured facing a surface to be illuminated. For example, in embodiments, the light generating system may be configured facing a wall. In other embodiments, the light generating system may be configured facing a floor or a ceiling. In yet other embodiments, the light generating system may be configured facing a horizontal work surface, e.g. a surface of a table, a surface of a dresser or a surface of a desk. The light generating system may also be configured facing any other surface, such as a surface of an object. The control system may, in embodiments, comprise a sensor capable of detecting the distance between the light generating system and the surface to be illuminated. Especially, the control system may be configured to control the intensity or color of the device light in response to changes in the distance. Hence, in embodiments, the control system may be configured to increase or decrease the brightness of the first (and/or second) linearly arranged light generating device when the distance to a surface illuminated by the light generating device increases. However, the control system may also be configured to increase or decrease the brightness of the first (and/or second) linearly arranged light generating device when the distance to a surface illuminated by the light generating device decreases. In other embodiments, the control system may be configured to change the color (gradient) of the first (and/or second) linearly arranged light generating device in response to a change in the distance to a surface illuminated by the light generating device.

In embodiments, the control system may be capable of detecting the distance between a light generating device and a surface illuminated by that light generating device. For example, the control system may comprise a sensor for the detection of distance between a light generating device and a surface illuminated by that light generating device. Especially, the sensor may detect the distance of the light generating device to a wall or to the ceiling. Such sensor signals may then be translated into the selection of a light setting that suits that distance, wherein the light output of the light generating device may be adjusted accordingly. In embodiments, detection of a short distance may lead a decrease in light output (e.g. brightness or color gradient). In other embodiments, the detection of a short distance may lead to an increase in light output (e.g. brightness or color gradient). Likewise, the light output (e.g. brightness or color gradient) may be adjusted in case of a long distance between the light generating device and the surface illuminated. Thus, in embodiments, the light generating system may use sensors to detect its distance to a surface. However, the control system of the light generating system may, in embodiments, also receive signals with the help of external smartphone sensors or with input from the user.

Further, in embodiments the light generating system may comprise a baffle element. Especially, in embodiments, the baffle element may be functionally coupled to at least one of the pivotable parts. Further, in embodiments, the baffle element may be at least partially configured between the first linearly arranged light generating device and the second linearly arranged light generating device. Yet further, in embodiments, the baffle element may be configured to limit overlap of beams of the first device light and the second device light. Hence, in a specific embodiment, the light generating system may comprise a baffle element, functionally coupled to at least one of the pivotable parts, at least partly configured between the first linearly arranged light generating device and the second linearly arranged light generating device, and configured to limit overlap of beams of the first device light and the second device light.

Hence, in embodiments, the light generating system comprises a unit, comprising the light generating devices, the pivotable parts, the central support, and the baffle element.

Inclusion of a baffle element into the light generating system may be beneficial as it may allow the user to separate the beams of two or more light generating devices. For example, when two light generating devices are configured to generate device light with each a different color a baffle element may ensure the separation of the beams of device light, and may thus prevent mixing of the colors. A baffle element may also provide the benefit of creating decorative light beam patterns. When using a baffle with a patterned shape, the baffle may allow partial mixing of light beams, which may provide decorative light beam patterns.

In embodiments, the light generating system may comprise a baffle element. The baffle element may, in embodiments, be a sheet, a plate or a rod. Especially, the baffle element may be a rectangularly shaped sheet or plate.

The baffle element may have a baffle element length L_{b} relative to the pivotable part lengths Lₚ. For example, in embodiments, the baffle element length L_{b} may be equal to the pivotable part lengths Lₚ, i.e. L_{b}=Lₚ. However, in other embodiments, the baffle element length L_{b} may not be equal to the pivotable part lengths Lₚ, i.e. the baffle element may be longer or shorter than the pivotable part lengths Lₚ.

The baffle element may further, in embodiments, have a width selected from the range of 2-50 cm, such as from the range of 5 -25 cm, like from the range of 5-10 cm. In embodiments, the baffle element may also have a thickness, selected from the range of 2-100 mm, such as from the range of 5-50 mm, like from the range of 10-25 mm.

Further, in embodiments, the baffle element may be functionally coupled to at least one of the pivotable parts. In embodiments, the baffle element may be functionally coupled to both the first pivotable part and the second pivotable part, i.e. the baffle element may be coupled in between the first and second pivotable parts (or on the hinge of the first and second pivotable parts). Especially, in embodiments, the baffle element may be at least partly configured between the first linearly arranged light generating device and the second linearly arranged light generating device.

Furthermore, the baffle element may, in embodiments, be configured pivotable relative to one or more of the first pivotable part and the second pivotable part. Hence, the baffle element may be able to pivot relative to one or more of the first pivotable part and the second pivotable part over the pivot axis Op. In embodiments, the baffle element may be pivotable relative to the first (and/or second) linearly arranged light generating device with a baffle pivot angle α_{b1} and/or α_{b2}. The baffle pivot angle α_{b1} and/or α_{b2} may be selected from the range of 5-355°, such as from the range of 35-315°, like from the range of 30-270°, especially from the range of 35-180°, like selected from the range of 45-180°.

Especially, in embodiments, the baffle element may be configured to limit overlap of beams of the first device light and the second device light. Hence, in embodiments, the baffle element may at least partially comprise a material which may be opaque. In other embodiments, the baffle element may at least partially comprise a material which may be reflective of the incident light beam. The baffle element may, in embodiments, at least partially comprise a material selected from the group comprising a metal, a polymeric material, a ceramic material, a wood material, a glass or a 3D printed material. In embodiments, for example, the first device light may be blue light and the second device light may be yellow light. In such an instance, the baffle element may limit overlap of the blue light beam with the yellow light beams, i.e. the baffle element may prevent the light beams from combining into green light.

Additionally or alternatively, in embodiments, the baffle element may have a shape selected from the group comprising a rectangular shape, a triangular shape, a crescent shape, an elliptic shape, and an irregular shape. Yet in alternative embodiments, the baffle element may also have a patterned shape, such as a pattern selected from the group comprising a sawtooth pattern, a rectangular pattern, a triangular pattern and a sine pattern. In such embodiments, the baffle may be configured to only partially limit overlap of the light beams of a first linearly arranged light generating device and a second linearly arranged light generating device. Hence, in embodiments, the resulting light incident on an illuminated surface may consist of a pattern of mixed and unmixed light beams.

In embodiments, the light generating system may further comprise a central support element. Especially, the pivotable parts may, in embodiments, be configured pivotable around the central support element. Further, the light generating system may comprise a central support element light generating device. The central support element light generating device may be configured to generate support element device light. Yet further, in embodiments, the central support element light generating device may comprise one or more central support element solid state light sources. In embodiments, the central support element may be configured to support the central support element light generating device. Hence, in a specific embodiment, the light generating system may further comprise a central support element, around which the pivotable parts may be configured pivotable; wherein the light generating system may further comprise a central support element light generating device, configured to generate support element device light; wherein the central support element light generating device may comprise one or more central support element solid state light sources; and wherein the central support element is configured to support the central support element light generating device.

Hence, in embodiments, the light generating system comprises a unit, comprising the light generating devices, the pivotable parts, and the central support.

With the present system, it may be possible to provide a light generating system with at least three different light sources, which may provide the possibility of generating three different colors of light simultaneously. Furthermore, it may be possible to create an improved gradient of colored light. Additionally or alternatively, the present system may improve the tunability of the light beam angles, light beam shapes and light beam colors.

In embodiments, the light generating system may comprise a central support element. Especially, in embodiments, the central support element may have a support element length Lop. The support element length Lop may, in embodiments, be selected from the range of 2 cm-10 m, such as from the range of 10 cm-5 m, like from the range of 50 cm-3 m, especially from the range of 100 cm-1 m. Further, in embodiments, the support element length L_{cp} may be selected such, that 0.01≤L_{cp}/Lₚ≤100 , like that 0.5≤L_{cp}/Lₚ≤50, especially that 1≤L_{cp}/Lₚ≤25.

Further, in embodiments, the central support element may have a shape selected from the group comprising, a (half) cylinder, a (polygonal) prism, a pipe, and a rod.

Yet further, in embodiments, the pivotable parts may be configured pivotable around the central support element.

In yet further embodiments, the light generating system may comprise a central support element light generating device. Especially, in embodiments, the central support element light generating device may be a linearly arranged central support element light generating device. More especially, in embodiments, the central support element may be configured to support the central support element light generating device. The (linearly arranged) central support element light generating device may be configured to generate support element device light. Further, in embodiments, the system light may comprise at least one or more of the first device light, the second device light, and the support element device light. In embodiments, the central support element light generating device may comprise one or more central support element solid state light sources.

A light generating device may especially be configured to generate device light. Especially, the light generating device may comprise a light source. The light source may especially be configured to generate light source light. In embodiments, the device light may essentially consist of the device light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, an LED (light emissive diode). In specific embodiments, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs.

Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light sources may be configured on the same substrate. In embodiments, a COB is a multi LED chip configured together as a single lighting module.

The term “light source” may also refer to a chip scaled package (CSP). A CSP may comprise a single solid state die with provided thereon a luminescent material comprising layer. The term “light source” may also refer to a midpower package. A midpower package may comprise one or more solid state die(s). The die(s) may be covered by a luminescent material comprising layer. The die dimensions may be equal to or smaller than 2 mm, such as in the range of e.g. 0.2-2 mm. Hence, in embodiments the light source comprises a solid state light source. Further, in specific embodiments, the light source comprises a chip scale packaged LED. Herein, the term “light source” may also especially refer to a small solid state light source, such as having a mini size or micro size. For instance, the light sources may comprise one or more of mini LEDs and micro LEDs. Especially, in embodiments the light sources may comprise micro LEDs or “microLEDs” or “μLEDs”.

Herein, the term mini size or mini LED especially indicates solid state light sources having dimensions, such as die dimensions, especially length and width, selected from the range of 100 μm-1 mm. Herein, the term u size or micro LED especially indicates solid state light sources having dimensions, such as die dimensions, especially length and width, selected from the range of 100 μm and smaller.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc. . . . The term “light source” may also refer to an organic light-emitting diode (OLED), such as a passive-matrix (PMOLED) or an active-matrix (AMOLED). In specific embodiments, the light source comprises a solid-state light source (such as an LED or laser diode). In embodiments, the light source comprises an LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a diode laser, or a superluminescent diode.

Hence, in embodiments, the central support element solid state light sources may be configured to generate central support element solid state light source light. Especially, central support element device light may comprise the central support element solid state light of one or more of the central support element solid state light sources.

Furthermore, in embodiments, the central support element light generating device may be configured to generate a central support element linear beam of central support element device light.

In specific embodiments, the central support element device light may be colored light.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In yet a further aspect, the invention also provides a lighting device such as a lamp or a luminaire, comprising the light generating system as defined herein. Such a lighting device may be beneficial as the hinging linear structure comprised by the lighting device may ease folding of the lighting device. Facile folding of the lighting device may result in more compact storage and transportation of the lighting device. The luminaire may further comprise a housing, optical elements, louvres, etc. etc. . . . The lamp or luminaire may further comprise a housing enclosing the light generating system. The lamp or luminaire may comprise a light window in the housing or a housing opening, through which the system light may escape from the housing. Hence, in an aspect the invention also provides a light generating device selected from the group of a lamp, a luminaire, a disinfection device, and an optical wireless communication device, comprising the light generating system as defined herein. The light generating device may comprise a housing or a carrier, configured to house or support, one or more elements of the light generating system. For instance, in embodiments the light generating device may comprise a housing or a carrier, configured to house or support one or more of the light generating devices, the pivotable parts, and the central support elements.

In embodiments, for example, the lighting device may comprise two or more linearly arranged light generating devices. Further, the lighting device may, in embodiments, comprise two or more pivotable parts configured to support the two or more linearly arranged light generating devices. Additionally or alternatively, in embodiments, the lighting device may comprise one or more central support elements, such as one central support element, like two central support elements, especially three central support elements.

Further, in embodiments, the lighting device may be of a type selected from the group comprising a standing lighting device, a table lighting device, a hanging lighting device, a handheld lighting device, or a pendant lighting device. Hence, in a specific embodiment, the lighting device may be a pendant lamp comprising three pivotable parts configured to support three light generating devices. These three pivotable parts may further be configured to pivot around two central support elements.

Yet further, in embodiments, the lighting device may comprise linearly arranged light generating devices, which may at least partially be configured in a vertical orientation. In other embodiments, the lighting device may comprise linearly arranged light generating devices, which may at least partially be configured in a horizontal orientation.

The lighting device may, in embodiments, comprise rectangular shapes.

In alternative embodiments, the lighting device may have curvi-linear shapes, for example, a shape selected from the group comprising a circular shape, a cylindrical shape, an oval shape, a beaded shape, a (double) crescent or moon shape, a heart shape, other types of regularly curved shapes, or an irregularly curved (or “asymmetrical”) shape.

In yet a further aspect, the invention also provides an arrangement comprising the light generating system. Especially, the light generating system may be configured to provide the first device light and the second device light to two respective items selected from a floor, a ceiling, a first wall, and a second wall (different from the first wall).

In embodiments, the arrangement may comprise a standing lamp arranged facing (the center of) a wall and configured to illuminate that wall. In other embodiments, the arrangement may comprise a standing lamp arranged in the corner of a room, i.e. facing two different adjacent walls, and configured to illuminate those two walls. In yet other embodiments, the arrangement may comprise a pendant or hanging lamp arranged hanging over a table or a floor. In such an instance the lamp may be configured to illuminate one or more of the table, the floor, and the ceiling.

The term “white light”, and similar terms, herein, are known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

In an embodiment, the light source may also provide light source light having a correlated color temperature (CCT) between about 5000 and 20000 K, e.g. direct phosphor converted LEDs (blue light emitting diode with thin layer of phosphor for e.g. obtaining of 10000 K). An advantage of the relatively high color temperature may be that there may be a relatively high blue component in the light source light.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light.

Instead of the terms “lighting device” or “lighting system”, and similar terms, also the terms “light generating device” or “light generating system”, (and similar terms), may be applied. A lighting device or a lighting system may be configured to generate device light (or “lighting device light”) or system light (“or lighting system light”). As indicated above, the terms light and radiation may interchangeably be used.

The term UV radiation may in specific embodiments refer to near UV radiation (NUV). Therefore, herein also the term “(N)UV” is applied, to refer to in general UV, and in specific embodiments to NUV. Herein, UV (ultraviolet) may especially refer to a wavelength selected from the range of 190-380 nm, though in specific embodiments other wavelengths may also be possible.

Herein, IR (infrared) may especially refer to radiation having a wavelength selected from the range of 780-3000 nm, such as 780-2000 nm, e.g. a wavelength up to about 1500 nm, like a wavelength of at least 900 nm, though in specific embodiments other wavelengths may also be possible. Hence, the term IR may herein refer to one or more of near infrared (NIR (or IR-A)) and short-wavelength infrared (SWIR (or IR-B)), especially NIR.

The term “centroid wavelength”, also indicated as 2c, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=>Σλ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1-3 schematically depict embodiments of the invention and some general aspects. The schematic drawings are not necessarily to scale.

### DETAILED DESCRIPTION OF THE EMBODIMENTS

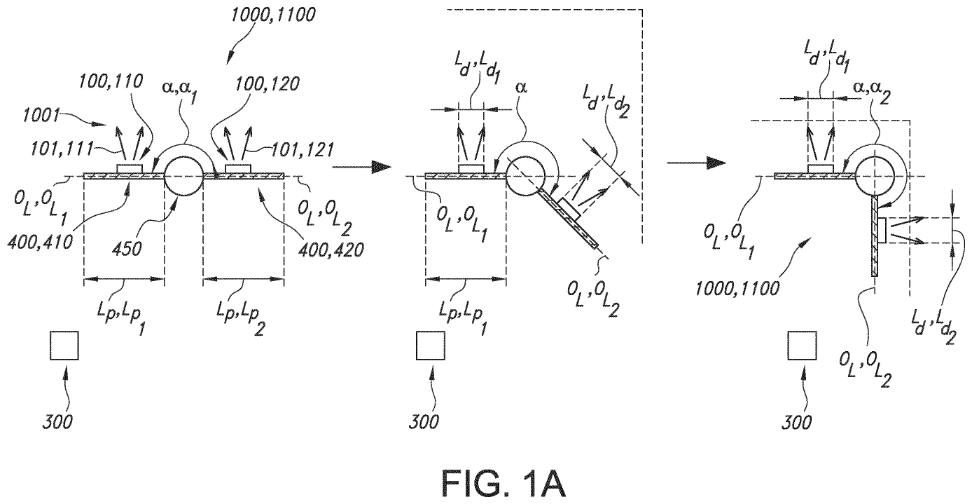

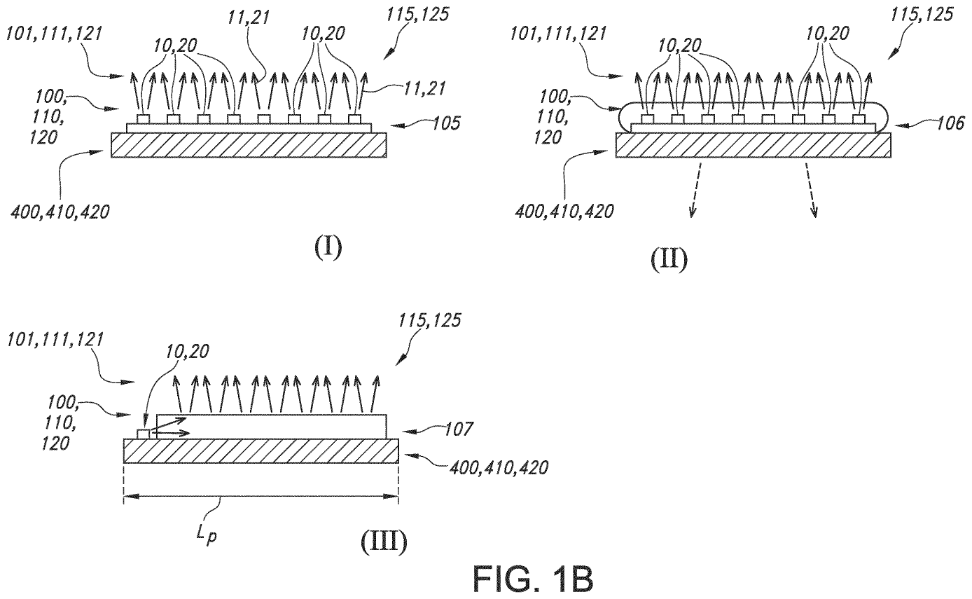

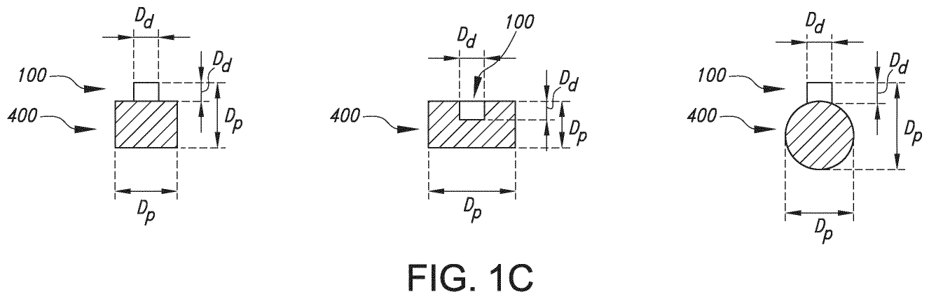

FIG. 1A schematically depicts embodiments of the invention. In embodiments, the invention may be a light generating system 1000 comprising light generating devices 100 and pivotable parts 400. Especially, in embodiments, the light generating devices 100 may comprise a first linearly arranged light generating device 110 and a second linearly arranged light generating device 120. More especially, in embodiments, the first linearly arranged light generating device 110 may be configured to generate first device light 111. Likewise, in embodiments, the second linearly arranged light generating device 120 may be configured to generate second device light 121. In embodiments, the first linearly arranged light generating device 110 and the second linearly arranged light generating device 120 may have a first linearly arranged light generating device length L_{d1} and a second linearly arranged light generating device length L_{d2}. Furthermore, in embodiments, the first linearly arranged light generating device 110 and the second linearly arranged light generating device 120 may have a cross-sectional dimension Dd. Further, FIG. 1a schematically depicts an embodiments of a unit 1100, comprising the light generating devices 100 and the pivotable parts 400 and the central support element. The latter is indicated with reference 450.

The pivotable parts 400 may, in embodiments, comprise a first pivotable part 410 and a second pivotable part 420. Further, the first pivotable part 410 and second pivotable part 420 may be configured pivotable relative to each other over a pivot axis Op. Yet further, in embodiments, the first pivotable part 410 may be configured to support the first linearly arranged light generating device 110. Likewise, the second pivotable part 420 may be configured to support the second linearly arranged light generating device 120.

In embodiments, the first linearly arranged light generating device 110 may comprise one or more first solid state light sources 10. Especially, the first linearly arranged light generating device 110 may, in embodiments, comprise a plurality of linearly arranged first solid state light sources 10. Likewise, in embodiments, the second linearly arranged light generating device 120 may comprise one or more second solid state light sources 20. Especially, the second linearly arranged light generating device 120 may, in embodiments, comprise a plurality of linearly arranged second solid state light sources 20. Additionally or alternatively, in a first operational mode of the light generating system 1000, the first device light 111 and the second device light 121 may differ in color point. Furthermore, in embodiments, the first linearly arranged light generating device 110 may be configured to generate a first linear beam 115 of first device light 111. Especially, the first solid state light sources 10 may be configured to generate first solid state light source light 11. More especially, in embodiments, the first device light 111 may comprise the first solid state light source light 11 of one or more of the first solid state light sources 10. Likewise, in embodiments, the second linearly arranged light generating device 120 may be configured to generate a second linear beam 125 of second device light 121. Especially, the second solid state light sources 20 may be configured to generate second solid state light source light 21. More especially, in embodiments, the second device light 121 may comprise the second solid state light source light 21 of one or more of the second solid state light sources 20.

In embodiments, a pivotable part may have a pivotable part axis of elongation O_{L}. Especially, in embodiments, the first pivotable part 410 may have a first pivotable part axis of elongation O_{L1}. Likewise, the second pivotable part 420 may have a second pivotable part axis of elongation O_{L2}. Optionally, at least one of the pivotable parts 410, 420 may additionally be pivotable over a respective pivotable part axis of elongation O_{L1}, O_{L2}, for example, pivotable over an angle range of 180°.

FIG. 1B schematically depicts some embodiments of the linearly arranged light generating devices. In embodiments. One or more of the first linearly arranged light generating device (110) and the second linearly arranged light generating device 120 may comprise one or more of: (i/I) a LED filament 106, (ii/II) a LED strip 105, and (iii/III) an elongated lightguide element 107 comprising linearly arranged light outcoupling parts.

Especially, in embodiments, in the first operational mode of the light generating system a first color point of the first device light 111 and a second color point of the second device light 121 may differ with at least 0.03 for u′ and/or with at least 0.03 for v′. Especially, u′ and v′ are color coordinates of the light in the CIE 1976 UCS (uniform chromaticity scale) diagram.

In embodiments, the pivotable parts 400 may comprise pivotable part lengths Lₚ, as schematically depicted in FIG. 1C. Furthermore, in embodiments, the pivotable parts 400 may comprise maximum cross-sectional dimensions Dₚ, as schematically depicted in FIG. 1C, configured perpendicular to the respective pivotable part lengths Lₚ. Especially, in embodiments, Lₚ/Dₚ≥5. Especially, in embodiments, the pivotable part lengths Lₚ may be selected from the range of 5-150 cm. Furthermore, the maximum cross-sectional dimensions may, in embodiments, be selected from the range of 2-50 mm.

Additionally or alternatively, in embodiments, the first (and/or second) linearly arranged light generating device 110 (and/or 120) may emit first (and/or second) device light 111 (and/or 121) over at least 50% of the pivotable part length Lₚ of the respective pivotable part 410 (and/or 420).

In further embodiments, the first pivotable part 410 and the second pivotable part 420 may have a mutual orientation over a pivot axis Op at a variable pivot angle α. Especially, in embodiments, a difference between a minimum pivot angle α₁ and a maximum pivot angle α₂ may be at least 45°. Additionally or alternatively, in embodiments, the difference between the minimum pivot angle α₁ and the maximum pivot angle α₂ may be selected from the range of 45-360°.

Yet further, in embodiments, at least one of the first linearly arranged light generating device 110 and the second linearly arranged light generating device 120 may be configured to generate colored device light.

Further, in embodiments, at least one of the first linearly arranged light generating device 110 and the second linearly arranged light generating device 120 may be configured to generate device light 101 having a controllable spectral power distribution.

In embodiments, the light generating system 1000 may comprise a second operational mode. Especially, in the second operational mode of the light generating system 1000 a spectral power distribution of at least one of the first device light 111 and the second device light 121 may spatially differ in color point along at least part of the pivotable part length Lₚ of the respective pivotable part.

Additionally or alternatively, in embodiments, the light generating system 1000 may be configured to generate system light 1001. Especially, the system light 1001 may comprise, in an operational mode of the light generating system 1000, device light 101 of at least one of the light generating devices 100. More especially, in embodiments, the system light 1001 may comprise, in an operational mode of the light generating system 1000, device light 101 of at least one of the first device light 111 and the second device light 121. Further, in embodiments, the light generating system 1000 may comprise a control system 300 configured to control the device light 101. Especially, the control system 300 may, in embodiments, be configured to control the device light 101 in dependence of one or more of an input signal of a user interface, a sensor signal of a sensor, and a timer.

Further, in embodiments, the control system 300 may be configured to control the device light 101 in dependence of the variable pivot angle α.

Yet further, in embodiments, the control system 300 may be configured to control the device light 101 in dependence of a distance to a surface illuminated by the light generating devices 100.

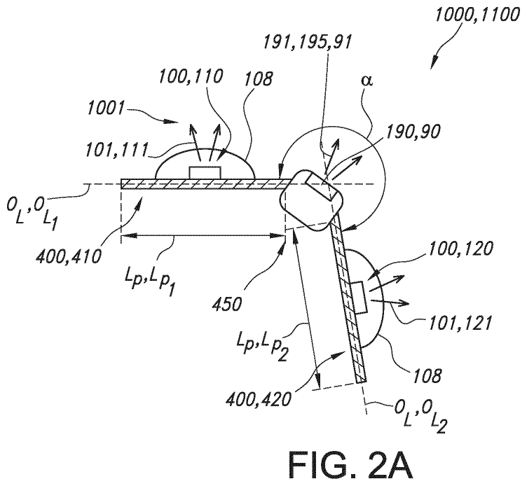

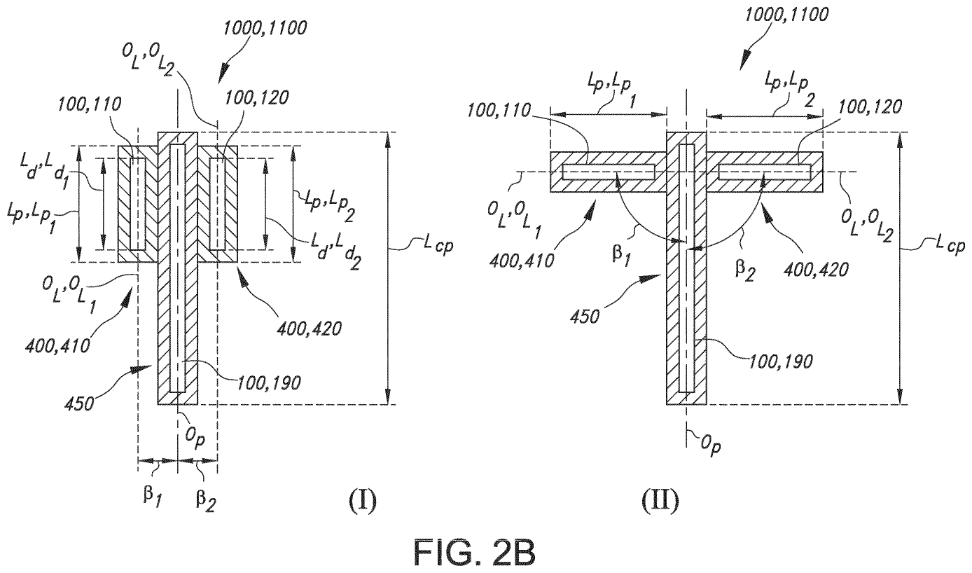

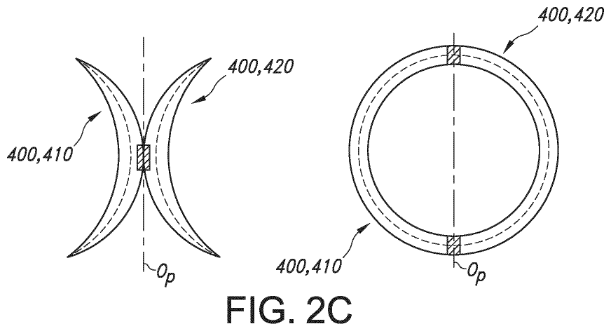

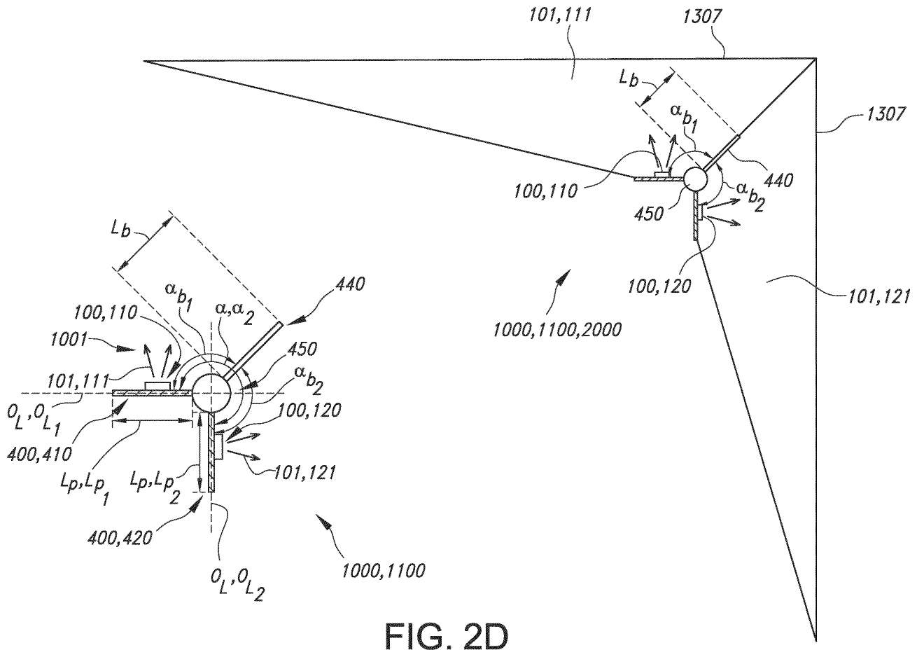

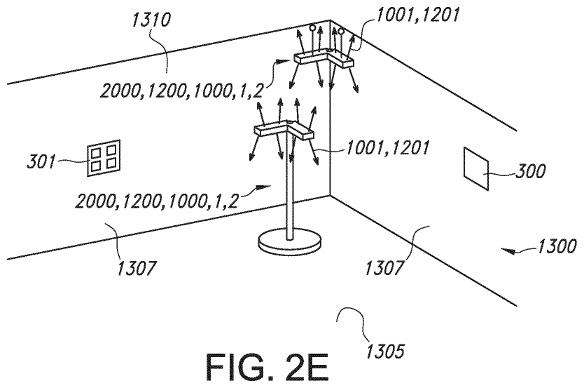

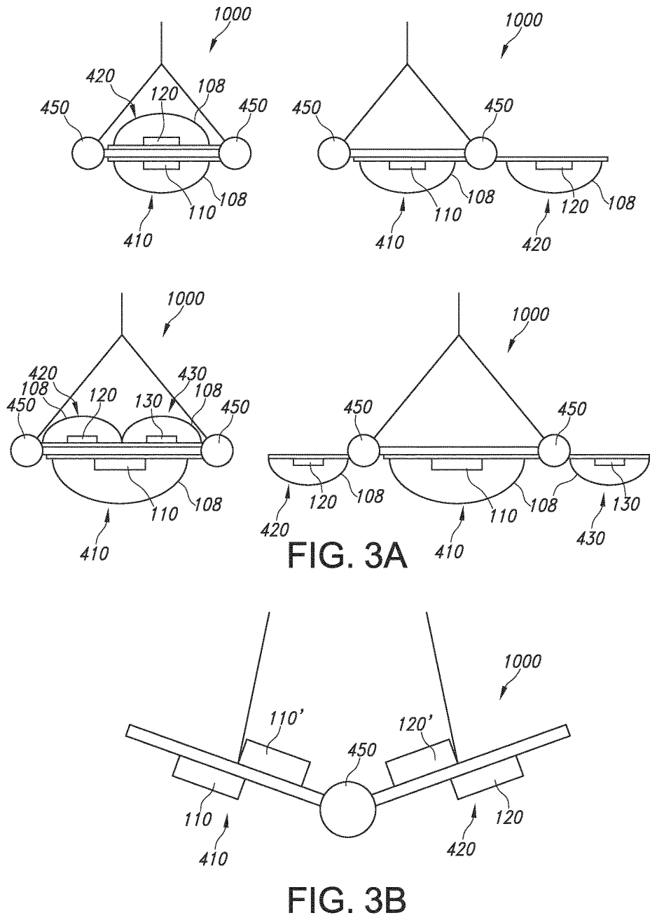

FIGS. 2A and 2B schematically depict the light generating system 1000 further comprising a central support element 450. Especially, the pivotable parts 400 may, in embodiments, be configured pivotable around the central support element 450. Further, the light generating system 1000 may comprise a central support element light generating device 190, especially a linearly arranged central support element light generating device 190. The central support element light generating device 190 may be configured to generate a central support element linear beam 195 of support element device light 191. Yet further, in embodiments, the central support element light generating device 190 may comprise one or more central support element solid state light sources 90. These central support element solid state light sources 90 may be configured to generate central support element solid state light source light. 91. Especially, in embodiments, the central support element device light 191 may comprise the central support element solid state light source light 91 of one or more of the central support element solid state light sources 90. In embodiments, the central support element 450 may be configured to support the central support element light generating device 190. Further, in embodiments, the central support element 450 may have a central support element length L_{cp} selected from the range of 2 cm-10 m. Especially, in embodiments, 0.01≤L_{cp}/Lₚ≤100. The linearly arranged light generating devices 100 may comprise, in embodiments, a diffuser 108, as depicted in FIG. 2A and FIG. 3A.

In embodiments, as depicted by FIG. 2B, the first linearly arranged light generating device 110 and the second linearly arranged light generating device 120 may either be configured parallel (I) in length to each other and the central support element 450, or perpendicular (II) in length to each other and the central support element 450.

The first pivotable part axis of elongation OLI and the second pivotable part axis of elongation O_{L2} may, in embodiments, be parallel (see FIG. 2B, (I)). In other embodiments, the first pivotable part axis of elongation O_{L1} and the second pivotable part axis of elongation O_{L2} may not be parallel, for example, the first pivotable part axis of elongation O_{L1} and the second pivotable part axis of elongation O_{L2} may coincide (see FIG. 2B (II)) or the first pivotable part axis of elongation OLI and the second pivotable part axis of elongation O_{L2} may be perpendicular. In yet other embodiments, the first pivotable part axis of elongation O_{L1} and the variable pivot axis may have a first mutual angle β₁. Likewise, the second pivotable part axis of elongation O_{L2} and the variable pivot axis may have a second mutual angle β2. The first and/or second mutual angles β₁ (and/or β₂) may be separately selected from the range of 0-180°, such as from the range of 0-90°, like from the range of 30-60°. Hence, a first and second mutual angle of 0° may indicate that the pivotable part axes of elongation O_{L} are parallel. Additionally or alternatively, a first and second mutual angle of 90° may indicate that the pivotable parts have pivotable part axes of elongation O_{L} that coincide. In an instance where, for example, the first mutual angle β₁ may be 0° and the second mutual angle β₂ may be 90°, the pivotable part axes of elongation O_{L} be perpendicular.

By way of example FIG. 2C schematically depicts a light generating system 1000 comprising crescent or half-circle shaped pivotable parts 400. The dotted lines may indicate the pivotable part lengths Lₚ of the in this case curved pivotable parts 400.

Additionally or alternatively, in embodiments the light generating system 1000 may comprise a baffle element 440, as depicted in FIG. 2D. Especially, in embodiments, the baffle element 440 may be functionally coupled to at least one of the pivotable parts 400. Further, in embodiments, the baffle element 440 may be at least partially configured between the first linearly arranged light generating device 110 and the second linearly arranged light generating device 120. Yet further, in embodiments, the baffle element 440 may be configured to limit overlap of beams of the first device light 111 and the second device light 121. In embodiments, the baffle element 440 may be configured pivotable relative to one or more of the first pivotable part 410 and the second pivotable part 420. The baffle element 440 may have a baffle element length L_{b} relative to the pivotable part lengths Lₚ. In embodiments, the baffle element may be relative to the first (and/or second) linearly arranged light generating device with a baffle pivot angle α_{b1} and/or α_{b2}. FIG. 2D also schematically depicts an embodiments of the unit 1100, comprising the light generating devices, the pivotable parts, the central support 450, and the baffle element 440.

FIG. 2D and FIG. 2E schematically depict an arrangement 2000 comprising the light generating system 1000. FIG. 2E further schematically depicts some embodiments of a lighting device 1200. In embodiments, a lighting device 1200 may be selected from the group of a lamp 1, a luminaire 2, a disinfection device, and an optical wireless communication device, comprising the light generating system 1000 as described herein. Reference 301 indicates a user interface which may be functionally coupled with the control system 300 comprised by or functionally coupled to the light generating system 1000. The figure also schematically depicts an embodiment of lamp 1 comprising the light generating system 1000. In embodiments, such lighting device may be a lamp 1, a luminaire 2, a disinfection device, or an optical wireless communication device. Lighting device light escaping from the lighting device 1200 is indicated with reference 1201. Lighting device light 1201 may essentially consist of system light 1001, and may in specific embodiments thus be system light 1001.

Reference 1300 indicates a space, such as an office or a living room, wherein the reference 1307 corresponds to the walls of the living room, reference 1305 corresponds to the floor, and reference 1310 corresponds to the ceiling.

In embodiments, the light generating system 1000 may comprise a standing or hanging (i.e. pendant) lighting device 1200. Further, in embodiments, the light generating system 1000 may comprise two or more linearly arranged light generating devices 100, two or more pivotable parts 400, and one or more central support elements 450. FIG. 3 schematically depicts examples of configurations for a hanging (or “pendant”) light generating system 1000. For example, a productivity light setting may be activated by the control system 300 when all linearly arranged light generating devices 100 are oriented downwards. Additionally or alternatively, an ambience creation setting may be activated for linearly arranged light generating devices 100, when oriented upwards to the ceiling. A combination of a productivity light setting and an ambience creation setting, i.e. a dual-function mode, may be achieved when orienting some linearly arranged light generating devices 100 upwards to the ceiling and some linearly arranged light generating devices 100 downwards, as is depicted in the examples in FIGS. 3A and 3B.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising (i) light generating devices and (ii) pivotable parts, wherein:
the light generating devices comprise (i) a first linearly arranged light generating device, configured to generate first device light, and (ii) a second linearly arranged light generating device, configured to generate second device light;
the pivotable parts comprise a first pivotable part and a second pivotable part, configured pivotable relative to each other over a pivot axis (Op); the first pivotable part is configured to support the first linearly arranged light generating device; the second pivotable part is configured to support the second linearly arranged light generating device;
the first linearly arranged light generating device comprises one or more first solid state light sources; the second linearly arranged light generating device comprises one or more second solid state light sources; and
in a first operational mode of the light generating system, the first device light and the second device light differ in color point,
wherein the first pivotable part and the second pivotable part have a mutual orientation over the pivot axis (Op) at a variable pivot angle (α),
wherein the light generating system in an operational mode is configured to generate system light comprising device light of at least one of the first device light and the second device light, wherein the light generating system further comprises a control system configured to control the device light, and
wherein during an on-state of the light generating system the control system is configured to control the system light in dependence of the variable pivot angle (α).

2. The light generating system according to claim 1, wherein the control of the system light in dependence of the variable pivot angle (α) relates to at least one of:
i) intensity level of at least one of the first device light and the second device light;
ii) intensity ratio of the first device light and second device light;
iii) emission spectrum of at least one of the first device light and the second device light; and
iv) difference in color, color temperature or correlated color temperature of the first device light and the second device light.

3. The light generating system according to claim 1, wherein in the first operational mode a first color point of the first device light and a second color point of the second device light differ with at least 0.03 for u′ and/or with at least 0.03 for v′.

4. The light generating system according to claim 1, wherein the pivotable parts comprise pivotable part lengths (Lₚ) and maximum cross-sectional dimensions (Dₚ), configured perpendicular to the respective pivotable part lengths (Lₚ), wherein Lₚ/Dₚ≥5.

5. The light generating system according to claim 4, wherein the pivotable part lengths (Lₚ) are selected from the range of 5-150 cm, and wherein the maximum cross-sectional dimensions (Dₚ) are selected from the range of 2-50 mm.

6. The light generating system according to claim 1, wherein a difference between a minimum pivot angle (α₁) and a maximum pivot angle (α₂) is selected from the range of 45-360°.

7. The light generating system according to claim 1, wherein at least one of the first linearly arranged light generating device and the second linearly arranged light generating device is configured to generate colored device light.

8. The light generating system according to claim 1, wherein at least one of the first linearly arranged light generating device and the second linearly arranged light generating device is configured to generate device light having a controllable spectral power distribution.

9. The light generating system according to claim 1, wherein in a second operational mode of the light generating system, a spectral power distribution of at least one of the first device light and the second device light spatially differ in color point along at least part of the pivotable part length (Lₚ) of the respective pivotable part.

10. The light generating system according to claim 1, wherein the first pivotable part and the second pivotable part are perpendicular in length to the central support element.

11. The light generating system according to claim 9, wherein the control system is configured to further control the system light in dependence of a distance to a surface illuminated by the light generating system.

12. The light generating system according to claim 1, further comprising a baffle element, functionally coupled to at least one of the pivotable parts, at least partly configured between the first linearly arranged light generating device and the second linearly arranged light generating device, and configured to limit overlap of beams of the first device light and the second device light.

13. The light generating system according to claim 1, further comprising a central support element, around which the pivotable parts are configured pivotable; wherein the light generating system further comprises a central support element light generating device, configured to generate support element device light wherein the central support element light generating device comprises one or more central support element solid state light sources; and wherein the central support element is configured to support the central support element light generating device.

14. A lighting device selected from the group of a lamp, a luminaire, disinfection device, and an optical wireless communication device, comprising the light generating system according to claim 1.

15. An arrangement comprising the light generating system according to claim 1, wherein the light generating system is configured to provide the first device light and the second device light to two respective items selected from a floor, a ceiling, a first wall, and a second wall, different from the first wall.
